(19) United States
(12) Patent Application Publication
(10) Pub. No.: US 2013/0159063 A1
(43) Pub. Date: Jun. 20, 2013

(54) PROCESS-BASED USER AUTHORIZATION MANAGEMENT

(71) Applicants: Joachim Fessler, Grafenberg (DE); Marianne Brosche, Heidelberg (DE); Ulrich Keil, Heidelberg (DE); Holger Knospe, Wiesloch (DE); Jochen Mayerle, Flein (DE)

(72) Inventors: Joachim Fessler, Grafenberg (DE); Marianne Brosche, Heidelberg (DE); Ulrich Keil, Heidelberg (DE); Holger Knospe, Wiesloch (DE); Jochen Mayerle, Flein (DE)

(21) Appl. No.: 13/326,261

(22) Filed: Dec. 14, 2011

(51) Int. Cl. G06Q 10/06

(52) U.S. Cl. 705/7.36

(57) ABSTRACT

A graphical display can concurrently include a plurality of organizational roles within an organization and a plurality of business process features of at least one business process within a business configuration of a scenario landscape of the organization. After receiving input that includes an assignment of a linkage between one of the plurality of organizational roles and one of the plurality of business process features via the graphical display from an authorized administrator-level user at the organization, a meta-model that includes metadata that defines a global set of linkages between business process features and organizational roles for the business configuration of the scenario landscape of the organization can be updated based on the received input.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-773F01U5/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

Participation in end-to-end business scenarios and processes in an organization, particularly in an organization that uses a business software architecture (e.g. an enterprise resource planning or ERP software system) to handle integrating business scenarios and processes across departments, grips divisions, etc. and multiple user roles that participate in those business scenarios and processes, can in some examples be subject to a certain tension for the users whose actions are necessary to complete an instance of the business scenario or process. Certain first business process features may lie within the responsibility of one or more first users who therefore require a certain level of access and control to be able to perform the necessary actions. Other, second business process features that are outside of the first users' area of responsibility and in the purview of one or more second users of the business process should still be visible to the first user but only in an informative manner. In other words, the first users may have read access to at least some of the data relating to the second business process features, but may be barred from write access (e.g. the ability to make changes, etc.). Still other, third business process features may involve sensitive information to which the first users are not allowed access, even on a read-only level. For these third business process features, the first users may or may not be allowed to view only status information (e.g. has a third business process feature been completed, is it in progress, etc.).

### SUMMARY

In one aspect, a method includes displaying, via a user interface presentable on a computer display device, a graphical display concurrently including a plurality of organizational roles within an organization and a plurality of business process features of at least one business scenario within a business configuration of a scenario landscape of the organization. Input that includes an assignment of a linkage between one of the plurality of organizational roles and one of the plurality of business process features is received via the graphical display from an authorized administrator-level user at the organization, and, based on the received input, a meta-model that includes metadata that defines a global set of linkages between business process features and organizational roles for the business configuration of the scenario landscape of the organization is updated.

In some variations one or more of the following features can optionally be included in any feasible combination. A determination can optionally be made whether a user profile of a business user includes a specific authorization level; an organizational role having the appropriate authorization level to handle the specific business process feature can be resolved for a specific business feature in an specific instance of a business scenario within the business configuration; and an identification can be made whether the business user has authority and/or responsibility for one or more of acting on the specific business process feature in the specific instance; observing the specific business process feature in the specific instance; and acknowledging the specific business process feature in the specific instance. A graphical representation of the business user's authority and/or responsibility status for a plurality of business process features in the specific instance of the business scenario can optionally be displayed to the business user. A visual indicator can optionally be displayed in the graphical display to identify at least one of the plurality of business process features that has not yet been assigned at least one of the plurality of organizational roles. A modified business scenario in the scenario landscape including a newly defined business process feature can optionally be displayed in a scenario overview map, and upon receiving a selection of the highlighted modified business scenario in the scenario overview map, navigation can occur to display the graphical display in the user interface to concurrently include the newly defined business process feature as part of the plurality of business process features of the modified business scenario and the plurality of organizational roles. The graphical display can optionally include a work frame and a scenario navigation frame. The scenario navigation frame can optionally include a first plurality of user interface elements arranged within the scenario navigation frame to represent at least some of the plurality of business process features, and the work frame can optionally include a plurality of organizational chart user interface elements.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, previously available business process management systems typically do not allow authorization previews of complete individual scenario or process instances or only provide a preview for the next process step (not the entire process). Offline solutions (e.g. the ARIS™ Process Performance Manager offered by Software AG of Darmstadt, Germany) are typically based on historical data as opposed to live, instance specific data, and therefore do not allow insight into individual process instances. To the extent that instance specific previews are possible with such tools, only a probability-based preview can be provided of most likely outcomes based previously entered decisions. A specific instance of a business process can often deviate arbitrarily far from such a probability-based prediction, thereby making previous approaches less representative of reality.

Other potential advantages of the current subject matter can include providing an innovative scenario overview and scenario navigation tool for software systems that incorporate complex business scenarios based on shared responsibilities. Typical examples of such software systems are ERP applications and other business software architectures for large, medium, and small enterprises. Examples of business scenarios that can be improved by implementations of the current subject matter can include, but are not limited to approval processes (one approver and one requestor role, enacted by different persons), complex scenarios that involve more than one role (e.g. buyer and seller, service provider and service consumer, etc.), and the like.

Each such scenario can include a certain inherent complexity, for example due to the different responsibilities of the different roles involved. Implementations of the current subject matter can provide full process transparency to end users, for example by displaying end-to-end scenario instances in a consumable manner that give clear information about who does what. Because real systems often do not use fixed responsibilities, but rather a set of complex responsibility rules (responsibilities can vary over time, by territory, material type, sales channel, etc.), each scenario instance can show greatly varying responsibility assignments. An instance-based end-to-end responsibility preview can include a visual tool that clearly differentiates between activities in a user's own responsibility and those in the responsibility of others. Different kinds of navigation can be indicated for these two categories of activities, so that the user knows what to expect from each activity.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screenshot of a user interface illustrating a linear single business scenario view and associated user interface features for guided pairing of organizational roles with aspects of a business process;

FIG. 2 shows an example of a graphical representation of data and action flows supporting an implementation of the current subject matter;

FIG. 3 shows a process flow diagram illustrating aspects of a method having one or more features consistent with implementations of the current subject matter;

FIG. 4 shows another process flow diagram illustrating aspects of a method having one or more features consistent with implementations of the current subject matter;

FIG. 5 is a diagram illustrating aspects of a system showing features consistent with implementations of the current subject matter;

FIG. 6 is a diagram illustrating aspects of a system showing features consistent with implementations of the current subject matter; and

FIG. 7 is a diagram illustrating a data repository showing features consistent with implementations of the current subject matter.

When practical, similar reference numbers denote similar structures, features, or elements.

### DETAILED DESCRIPTION

Productive tools for providing scenario visualization and/or scenario navigation information while also giving a user accurate preview of an overall business scenario authorization scheme (e.g. mapped at the level of tasks, process steps, sub-processes, or other business process features) have generally been unavailable.

User authorization assignment in currently available business software architectures can generally be achieved using a multi-level process. Customizing authorization management settings can typically only be done in a functional way—for example, mappings between a business process feature (e.g. a business process, a process step, a sub-process, a task, etc.) and the corresponding required user authorization settings are typically not available via a unified, easily navigable view of the business scenario. Accordingly, to the extent that scenario navigation capabilities are included in currently available business software architectures, such capabilities generally lack the ability to detect a) whether a business user (used generically herein to refer to one or more members of an organization having common authorizations or permissions, e.g. a common organizational role, a group of roles, members of a department, etc.) is allowed to execute a specific business process feature; b) which business process feature is executed by which user; or c) which business process feature lacks an assignment to a user. Especially during the implementation and configuration phase of a business software architecture, scenario or process-based authorization management coupled with a scenario navigation tool can accelerate and facilitate the tasks associated with user authorization management.

To address these and potentially other issues with currently available solutions, methods, systems, articles of manufacture, and the like consistent with one or more implementations of the current subject matter can, among other possible advantages, provide the ability to link each business process feature to the authorization settings required to enact that business process feature. Graphical visualizations of a business scenario, such as for example those described in one or more of the related applications listed above, can provide a platform to provide a scenario-based view on business user authorization settings and/or master-data settings on a feature-by-feature level within the business scenario. This scenario-based user authorization approach can easily and conveniently ensure that each business user in an organization is provided with the correct set of authorizations to fulfill his or her core business role. For example, situations in which a business user lacks sufficient authorizations to complete an approved task can be avoided as can situations in which the business user is given more access than he or she should according to his or her role, position, etc. In further implementations, a simulation tool can be used to predict a decision path through a business scenario model, for example based on concrete, instance-specific data currently available in a given scenario instance, such that a scenario monitor, legal counselor, etc. can quickly and visually determine whether the segregation of duty requirements are met for a given scenario model as well as for each individual scenario instance in question.

One or more administrators within the organization can use an integrated visualization of business process features to assign business process feature-based authorization rights to any business user by interacting with user interface elements of a scenario navigation pane displayed concurrently with a work pane showing user interface elements relating to organizational positions. This functionality can be provided via a realistic representation of the organization's current business scenario landscape that is based on mapping information between business process features and the specific authorization management settings that is stored in a scenario meta-model. The scenario meta-model also includes mapping information between a business process feature and corresponding locations of an underlying user authorization management process.

In some examples, an administrator may not be able to adapt all authorization rights for all business process features in the business scenario landscape in one session. Accordingly, implementations of the current subject matter can also provide visual indicators (e.g. via icons, graphical links, colors, text formatting cues, and the like) of current authorization management setting status, for example by visually indicating which business process features are not currently assigned to at least one user, role, department, etc. and/or which business users, roles, etc. are not currently assigned to at least one business process feature. Changes made to authorization management settings can be immediately reflected in a corresponding view of the affected business process, for all selected users, across the entire business software architecture as used by the organization.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

According to implementations of the current subject matter, business process features that lie in the responsibility of a specific organizational role (a term that is henceforth used to refer generically to a business user, a group of business users, a specific organizational role, a permissions level, a department, a division, etc.) can be clearly distinguishable from business process features that require only an observer role for a specific organizational role. Business process features that lie in the responsibility of other organizational roles (e.g the current organizational role has restricted access, such as read only or status only access) can also be clearly distinguishable from those business process features for which the specific organizational role has direct responsibility.

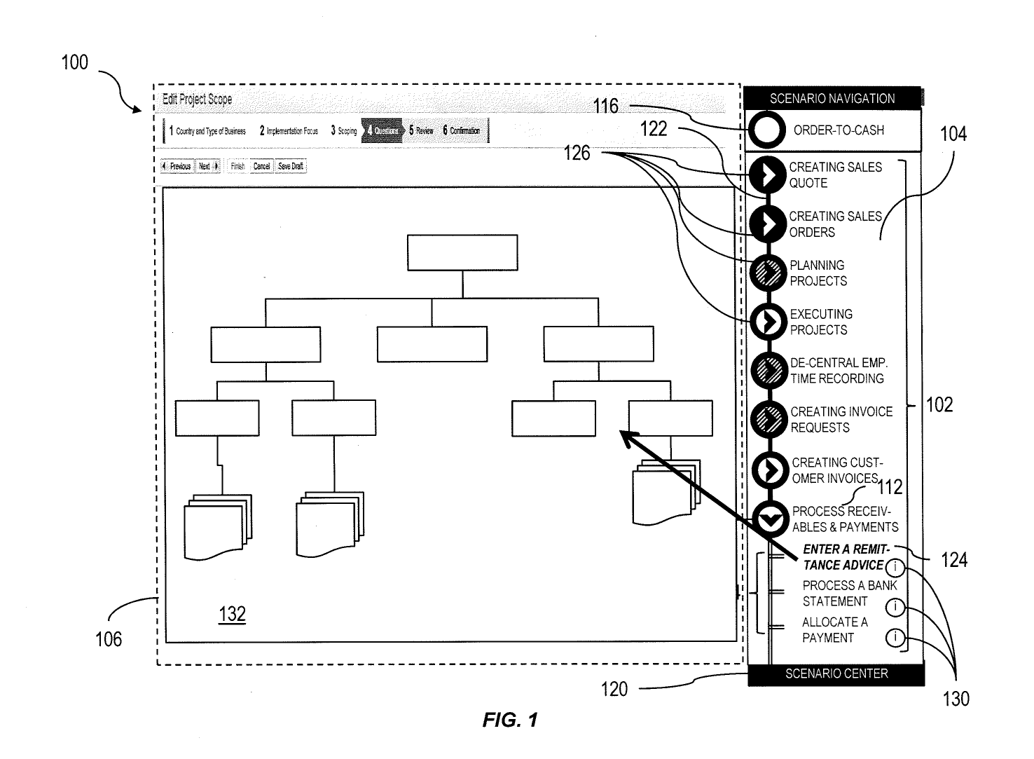

FIG. 1 illustrates an example of a linear single scenario view 100, which shows a single business scenario represented by a plurality of first user interface elements 102 in a navigation pane 104. The plurality of first user interface elements 102 are arranged to represent the business scenario as a linear sequence of business process features, which can in turn each include additional nested business process features. The structure of the business scenario is condensed into a linear view, even though the actual flow of tasks and other actions necessary to complete an instance of the business scenario often involves explicit parallelism, decisions, loops, event driven changes in control flow, exceptions, and the like. Consistent with the scope of the current subject matter, any viable approach can be used to shape a business scenario into such a linear view.

As shown in FIG. 1, a scenario navigation pane 104 and a work pane 106 are concurrently displayed. One or more user interface elements of the plurality of first user interface elements 110 corresponding to a business process 112 having process steps can be expanded as shown in FIG. 1 to display additional user interface elements 114 corresponding to the process steps and/or additional sub-steps, tasks, etc. Also as shown in FIG. 1, the currently active business scenario can be identified by one or more scenario identifier user elements 116. A scenario browser or scenario center, etc. user interface element 120 can link to an upper level scenario landscape overview map to display an overall scenario landscape map showing intersections between processes and providing links to navigate to the other scenarios in the scenario landscape.

The first user interface elements 102 can optionally be displayed in a manner similar to a transit route map with each business process feature being represented like a stop on the route. In this manner, a familiar visual format can rapidly convey additional information about a current context within a specific instance of the business scenario as well as status information about the various business process features along the “route” to completion of the instance. For example, a route line 122 connecting the “stops” can be presented with a first visual effect (e.g. color, brightness, shade, dots or dashes, etc.) up to the “stop” representing the business process feature that is currently “active” with related functionality being provided in the work pane 106. The currently active business process feature can be further indicated using textual or visual cues, such as for example color, shading, font, a highlighting box, etc. As a non-limiting example, the name of the business process displayed in conjunction with the user interface element 124 corresponding to the currently active business process in FIG. 1 is formatted in a bold and italicized font. A different second visual effect can be used for the part of the route line 122 leading to the “stops” past the currently active business process feature. The icons 126 used to represent the “stops” in the scenario navigation pane can also include visual cues to inform a user about status, other business process feature that are included within the currently displayed business process feature user interface elements and that can be revealed by a user action to expand the route map, or the like.

Additional first user interface elements 130 (e.g. the encircled “i” icons shown in FIG. 1) can provide additional details about one or more of the business process feature. For example, selection by user of one of these additional user interface elements 130 can cause the work pane 106 to display a set of business configuration user interface elements 132 via which a change in one or more functional details relating to the selected business process feature can be made The functional details can include functions, features, etc. provided by the underlying business software architecture and/or by external service provider software (e.g. third-party programs, modules, etc. providing functionality that is integrated within the business software architecture). In the example shown in FIG. 1, selection of the additional first user interface elements 130 corresponding to the business process of “enter a remittance advice” links in the work pane 106 to a screen displaying payment method options with a set of business configuration user interface elements that include organizational chart user interface elements 132 that allow a business user to determine and/or remedy those business process features that do not currently have a valid assignment to at least one employee, member, etc. of the organization. Conversely, it can be equally easy to identify whether every employee, member, etc. or role of the organization company is allocated to at least one business process feature. Reassignments of roles, tasks, etc. among the members of an organization can be performed visually, for example using a drag and drop functionality via which a first user interface element corresponding to a business process feature of the business scenario displayed in the scenario navigation pane 104 is dragged onto an organizational chart user interface element 132 in the work. The converse can also occur, in which an organizational chart user interface element 132 from the work pane 106 is dragged onto a first user interface element 102 in the scenario navigation pane 104 to make a linkage between task and person or role or department, etc.

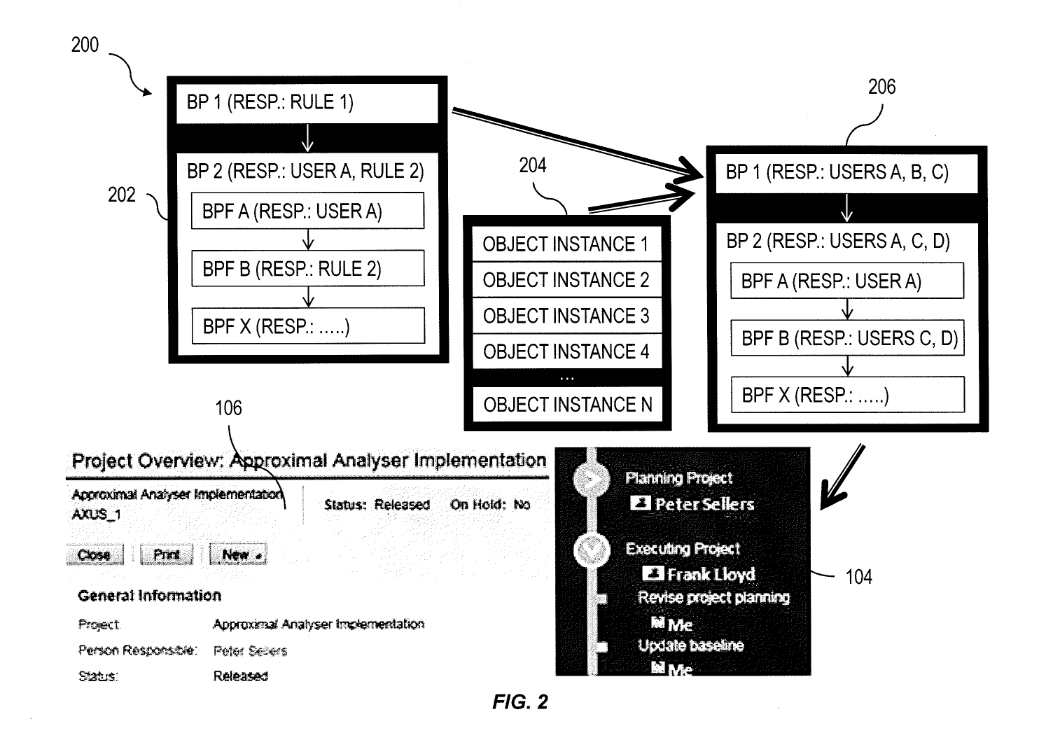

FIG. 2 shows a graphical representation of a data and/or action flow 200 that can support implementations of the current subject matter. A business configuration meta-model 202, which can include, but is not limited to, definitions of business processes (abbreviated as BP in FIG. 2) and business process features (e.g. process steps, sub-processes, tasks, etc., abbreviated as BPF in FIG. 2) and responsibility information for the business processes and business process features. The responsibility information can optionally be defined as either one or more of specific users, specific user roles, rules defining characteristics of user roles, or the like. The business configuration meta-model can, in conjunction with instance context data provided by concrete instances of objects 204 (e.g. business objects, data objects, etc.) relating to specific instances of the business processes defined in the business scenario meta-model, be populated with concrete data relating to these instances to create a context-specific instance of the business configuration 206. The context-specific instance of the business configuration can provide support for displaying, for example in the navigation pane 104 and/or work pane 106 of a user interface, the responsibility information in a manner that allows easy identification of responsible roles, people, etc. for each business process feature and that can also highlight roles lacking a link to a business process feature and/or a business process feature lacking role, person, etc. to whom responsibility for that business process feature is assigned.

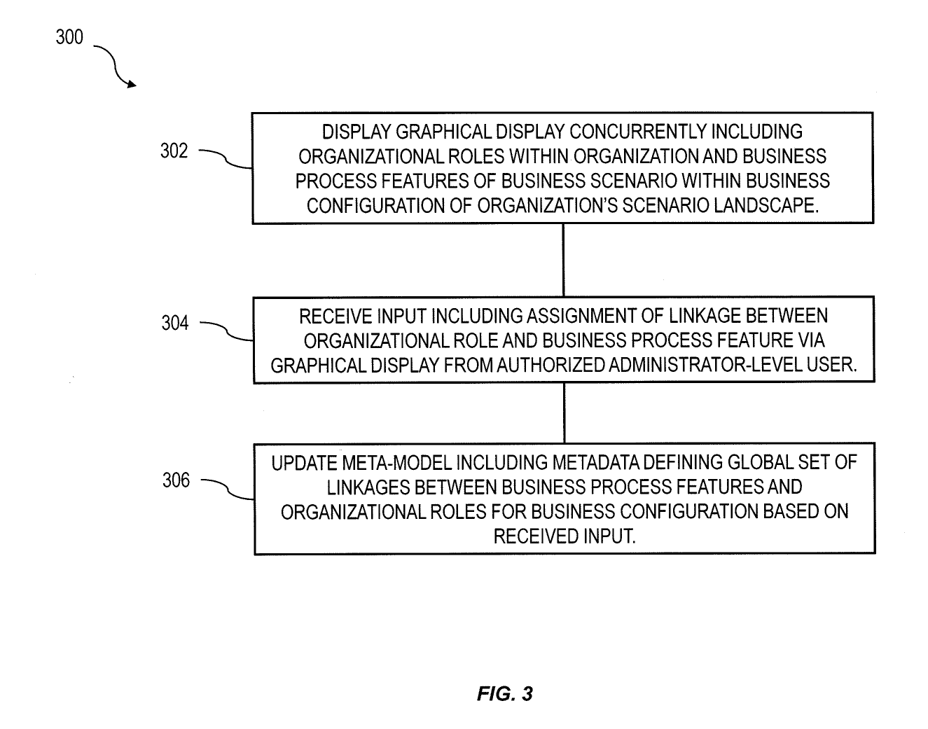

FIG. 3 shows a process flow chart 300 illustrating a method having one or more features consistent with implementations of the current subject matter. At 302, a user interface presentable on a computer display device displays a graphical display that concurrently includes a plurality of organizational roles within an organization and a plurality of business process features of at least one business scenario within a business configuration of a scenario landscape of the organization. Input is received at 304 via the graphical display from an authorized administrator-level user at the organization. The input includes an assignment of a linkage between one of the plurality of organizational roles and one of the plurality of business process features. At 306, a meta-model comprising metadata that defines a global set of linkages between business process features and organizational roles for the business configuration of the scenario landscape of the organization is updated based on the received input.

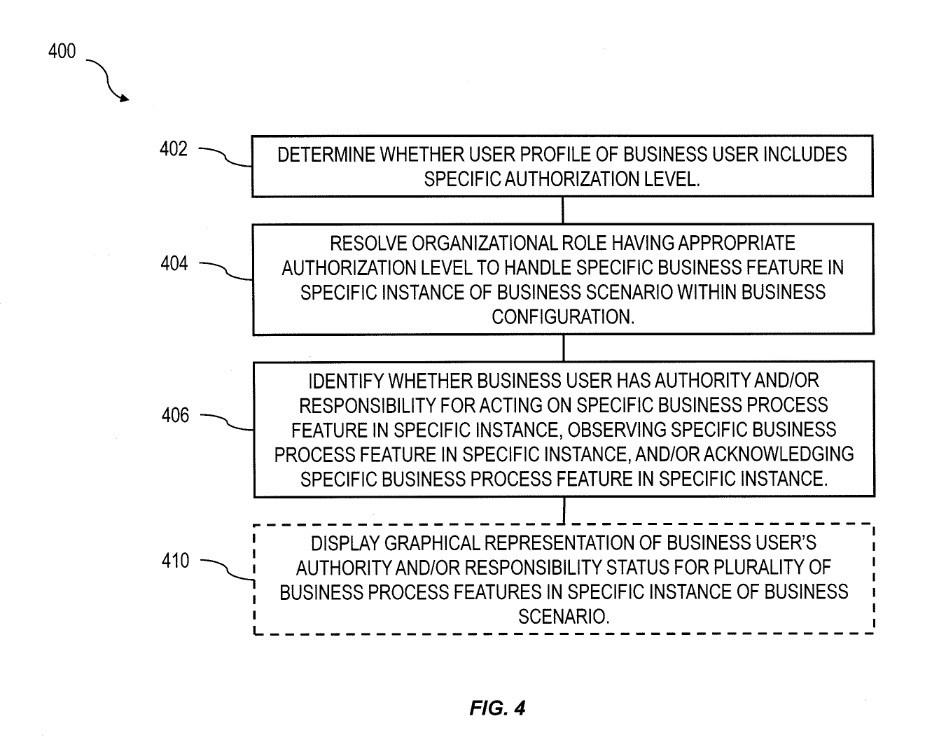

According to some implementations of the current subject matter, an authorization engine or other control approach can match the role, position, permissions level, etc. of a business user (generically referred to herein as role information) with responsibility determination rules that can be associated with each business process feature of the business scenarios within an organization's business configuration. FIG. 4 shows another process flow chart 400 illustrating a method having one or more features consistent with implementations of the current subject matter. At 402, a business user's profile can be checked to determine whether it includes a specific authorization. This check can be performed even if the business user is not currently attempting to invoke a protected action, for example as part of an authorization check on a simulated action. Using an application programming interface (API) or other comparable approach to access data and/or metadata relating to permissions associated with a business user's profile, a preview of how the authorization profile of the business user matches any given business process feature of a business process and/or business configuration can be generated. At 404, a organizational role having the appropriate authorization level to handle a specific business process feature can be resolved, for example by providing a list of business users who currently have the necessary authorization level. This organizational role can be compared with the business user's profile to identify at 406, whether, for a specific business process feature in a specific instance of a business scenario, the business user has authority and/or responsibility to act on the business process feature; observe, supervise, etc. the business process feature; and/or acknowledge (and optionally draw information from) the business process feature. At determination can also optionally be made whether another business user is responsible for the business process feature and if so, the identity of that business user can also be determined. These determinations can be completed for all business process features of a scenario instance, even if the business process features have not yet been started.

One or more user interface components can optionally display information related to an active instance of a business scenario to a business user at 410, for example showing whether or not the business user is responsible for any given activity, the permissions/responsibility level (e.g. actor, observer, etc.) of the business user for all or some business process features of the business scenario for which he or she is responsible, and, if the business user is not responsible for the business process feature, contact information about one or more responsible other business users can be provided. Positively displaying business process features for which the business user has responsibilities can help to focus the business user on his or her appointed tasks while providing a quick navigation to the relevant user interfaces, transaction screens, etc. in the system or, via URL, to external systems or services providing support to carry out the task. Clearly indicating which business process features are not within the responsibility of the business user can also avoid errant navigation to business process features where only an error message would await the business user (e.g. “you are not authorized to access this information”). Business process features for which other business users are responsible could lead the business user to directly and conveniently get in touch with the responsible other business user, for example by offering, via the user interface, to send an e-mail with a pre-filled mail body pointing to the business process feature in question and by attaching relevant objects related to this particular instance of the business process feature. Displaying both kinds of business process features, e.g. those for which the business user is responsible and those for which the business user is not, can permit the business user to get a full end-to-end scenario overview without getting lost in details for which that business user is not responsible.

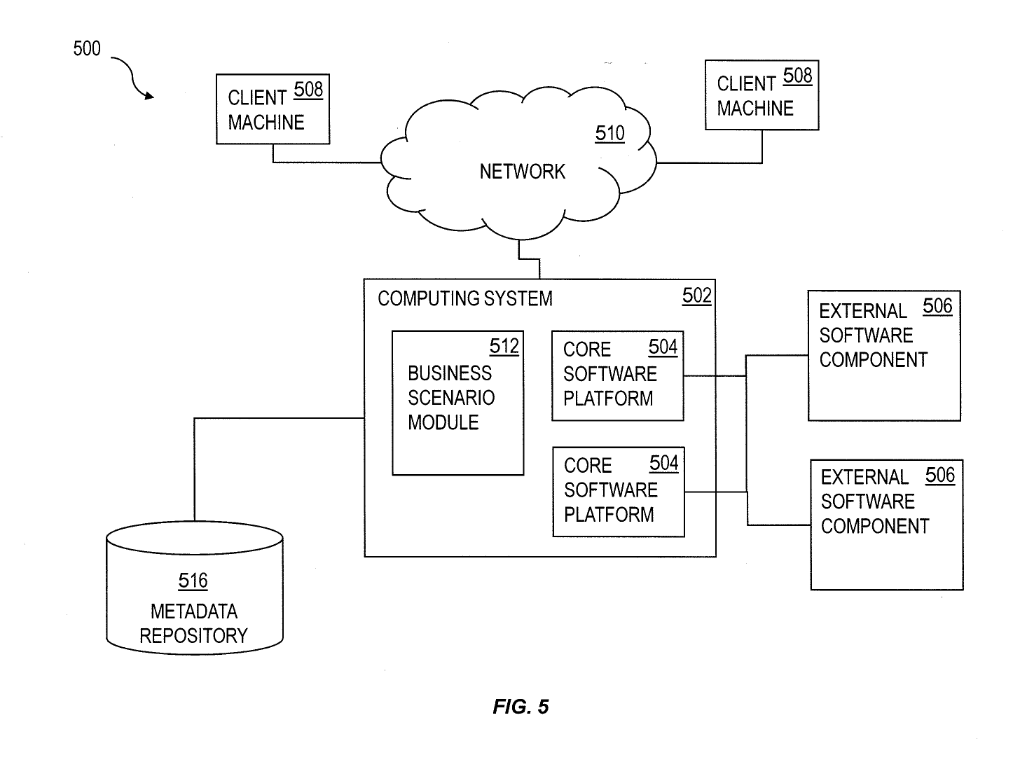

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 5 shows a diagram of a system consistent with such an implementation. A computing system 502 can include one or more core software platform modules 504 providing one or more features of the ERP system. The computing system can also aggregate or otherwise provide a gateway via which users can access functionality provided by one or more external software components 506 that can, in some implementations be supported by service providers external to the core software platform modules. Client machines 508 can access the computing system, either via a direct connection, a local terminal, or over a network 510 (e.g. a local area network, a wide area network, a wireless network, the Internet, or the like). A business process guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The scenario process guidance and recording module 512 can access one or more metadata repositories 516 and/or other data repositories that can store the definition of business scenarios, business processes, and business configuration as well as data, metadata, master data, etc. relating to definitions of the business scenarios and business processes, the business configuration, and/or concrete instances of the data objects (e.g. business objects) that are relevant to a specific instance of the business scenario. In some examples, the definition can optionally be stored as a business object. In some implementations, the business object can include a template definition of a standard business scenario or business process. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

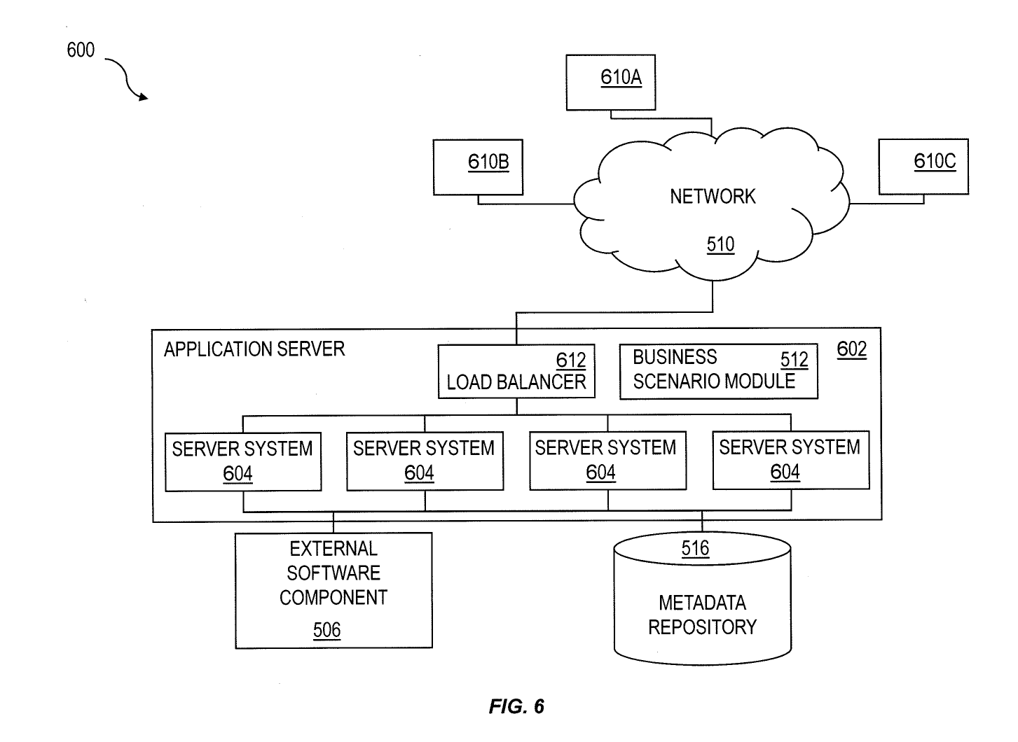

FIG. 6 shows a block diagram of a multi-tenant implementation of a software delivery architecture 600 that includes an application server 602, which can in some implementations include multiple server systems 604 that are accessible over a network 606 from client machines operated by users at each of multiple organizations 610A-610C (referred to herein as “tenants” of a multi-tenant system) supported by a single software delivery architecture 600. For a system in which the application server 602 includes multiple server systems 604, the application server can include a load balancer 612 to distribute requests and actions from users at the one or more organizations 610A-610C to the one or more server systems 604. Instances of the core software platform 504 (not shown in FIG. 6) can be executed in a distributed manner across the server systems 604. A user can access the software delivery architecture across the network using a thin client, such as for example a web browser or the like, or other portal software running on a client machine. The application server 602 can access data and data objects stored in one or more data repositories 516. The application server 602 can also serve as a middleware component via which access is provided to one or more external software components 506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 5, the metadata repository 516 can store a business object that represents a template definition of a standard business process. Each individual tenant 610A-610C can customize that standard template according to the individual business process features specific to business of the organization to which that tenant is assigned. Customizations can be stored as extensions in the metadata repository.

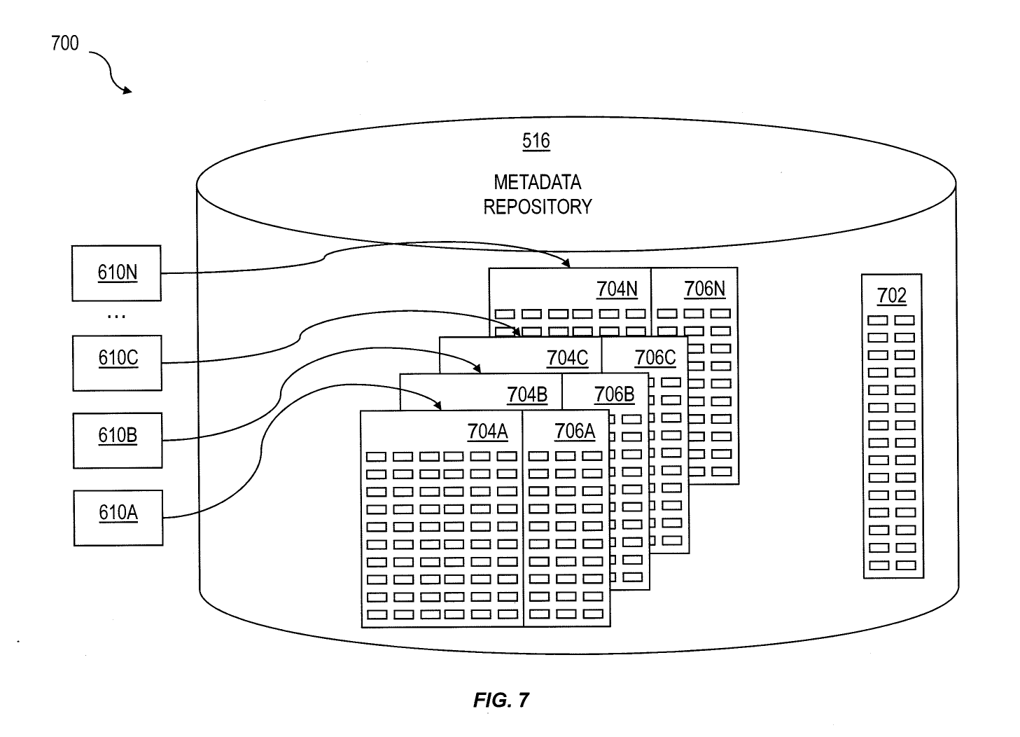

To provide for customization of the business process for each of multiple organizations supported by a single software delivery architecture 600, the data and data objects stored in the metadata repository 516 and/or other data repositories that are accessed by the application server 602 can include three types of content as shown in FIG. 7: core software platform content 702 (e.g. a standard definition of a business process), system content 704 and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
displaying via a user interface presentable on a computer display device, a graphical display concurrently comprising a plurality of organizational roles within an organization and a plurality of business process features of at least one business scenario within a business configuration of a scenario landscape of the organization;
receiving input via the graphical display from an authorized administrator-level user at the organization, the input comprising an assignment of a linkage between one of the plurality of organizational roles and one of the plurality of business process features; and
updating, based on the received input, a meta-model comprising metadata that defines a global set of linkages between business process features and organizational roles for the business configuration of the scenario landscape of the organization.

2. A computer program product as in claim 1, wherein the operations further comprise:
determining whether a user profile of a business user includes a specific authorization level;
resolving, for a specific business feature in an specific instance of a business scenario within the business configuration, an organizational role having the appropriate authorization level to handle the specific business process feature; and
identifying whether the business user has authority and/or responsibility for one or more of acting on the specific business process feature in the specific instance; observing the specific business process feature in the specific instance; and acknowledging the specific business process feature in the specific instance.

3. A computer program product as in claim 1, wherein the operations further comprise displaying, to the business user, a graphical representation of the business user's authority and/or responsibility status for a plurality of business process features in the specific instance of the business scenario.

4. A computer program product as in claim 1, wherein the operations further comprise providing a visual indicator in the graphical display to identify at least one of the plurality of business process features that has not yet been assigned at least one of the plurality of organizational roles.

5. A computer program product as in claim 1, wherein the operations further comprise:
highlighting, in a scenario overview map, a modified business scenario in the scenario landscape, the modified business scenario comprising a newly defined business process feature, and
navigating to display, in the user interface upon receiving a selection of the highlighted modified business scenario in the scenario overview map, the graphical display concurrently comprising the newly defined business process feature as part of the plurality of business process features of the modified business scenario and the plurality of organizational roles.

6. A computer program product as in claim 1, wherein the graphical display comprises a work frame and a scenario navigation frame, the scenario navigation frame comprising a first plurality of user interface elements arranged within the scenario navigation frame to represent at least some of the plurality of business process features, and the work frame comprising a plurality of organizational chart user interface elements.

7. A system comprising:
at least one programmable processor; and
a machine-readable medium storing instructions that, when executed by the at least one processor, cause the at least one programmable processor to perform operations comprising:
displaying via a user interface presentable on a computer display device, a graphical display concurrently comprising a plurality of organizational roles within an organization and a plurality of business process features of at least one business scenario within a business configuration of a scenario landscape of the organization;
receiving input via the graphical display from an authorized administrator-level user at the organization, the input comprising an assignment of a linkage between one of the plurality of organizational roles and one of the plurality of business process features; and
updating, based on the received input, a meta-model comprising metadata that defines a global set of linkages between business process features and organizational roles for the business configuration of the scenario landscape of the organization.

8. A system as in claim 7, wherein the operations further comprise:
determining whether a user profile of a business user includes a specific authorization level;
resolving, for a specific business feature in an specific instance of a business scenario within the business configuration, an organizational role having the appropriate authorization level to handle the specific business process feature; and
identifying whether the business user has authority and/or responsibility for one or more of acting on the specific business process feature in the specific instance; observing the specific business process feature in the specific instance; and acknowledging the specific business process feature in the specific instance.

9. A system as in claim 7, wherein the operations further comprise displaying, to the business user, a graphical representation of the business user's authority and/or responsibility status for a plurality of business process features in the specific instance of the business scenario.

10. A system as in claim 7, wherein the operations further comprise providing a visual indicator in the graphical display to identify at least one of the plurality of business process features that has not yet been assigned at least one of the plurality of organizational roles.

11. A system as in claim 7, wherein the operations further comprise:
highlighting, in a scenario overview map, a modified business scenario in the scenario landscape, the modified business scenario comprising a newly defined business process feature, and
navigating to display, in the user interface upon receiving a selection of the highlighted modified business scenario in the scenario overview map, the graphical display concurrently comprising the newly defined business process feature as part of the plurality of business process features of the modified business scenario and the plurality of organizational roles.

12. A system as in claim 7, wherein the graphical display comprises a work frame and a scenario navigation frame, the scenario navigation frame comprising a first plurality of user interface elements arranged within the scenario navigation frame to represent at least some of the plurality of business process features, and the work frame comprising a plurality of organizational chart user interface elements.

13. A computer-implemented method comprising:
displaying via a user interface presentable on a computer display device, a graphical display concurrently comprising a plurality of organizational roles within an organization and a plurality of business process features of at least one business scenario within a business configuration of a scenario landscape of the organization;
receiving input via the graphical display from an authorized administrator-level user at the organization, the input comprising an assignment of a linkage between one of the plurality of organizational roles and one of the plurality of business process features; and
updating, based on the received input, a meta-model comprising metadata that defines a global set of linkages between business process features and organizational roles for the business configuration of the scenario landscape of the organization.

14. A computer-implemented method as in claim 13, wherein further comprising:
determining whether a user profile of a business user includes a specific authorization level;
resolving, for a specific business feature in an specific instance of a business scenario within the business configuration, an organizational role having the appropriate authorization level to handle the specific business process feature; and
identifying whether the business user has authority and/or responsibility for one or more of acting on the specific business process feature in the specific instance; observing the specific business process feature in the specific instance; and acknowledging the specific business process feature in the specific instance.

15. A computer-implemented method as in claim 13, wherein further comprising displaying, to the business user, a graphical representation of the business user's authority and/or responsibility status for a plurality of business process features in the specific instance of the business scenario.

16. A computer-implemented method as in claim 13, wherein further comprising providing a visual indicator in the graphical display to identify at least one of the plurality of business process features that has not yet been assigned at least one of the plurality of organizational roles.

17. A computer-implemented method as in claim 13, wherein further comprising:
highlighting, in a scenario overview map, a modified business scenario in the scenario landscape, the modified business scenario comprising a newly defined business process feature, and
navigating to display, in the user interface upon receiving a selection of the highlighted modified business scenario in the scenario overview map, the graphical display concurrently comprising the newly defined business process feature as part of the plurality of business process features of the modified business scenario and the plurality of organizational roles.

18. A computer-implemented method as in claim 1, wherein the graphical display comprises a work frame and a scenario navigation frame, the scenario navigation frame comprising a first plurality of user interface elements arranged within the scenario navigation frame to represent at least some of the plurality of business process features, and the work frame comprising a plurality of organizational chart user interface elements.

19. A computer-implemented method as in claim 13, wherein at least one of the displaying the receiving, and the updating is performed by at least one programmable processor.
